(19) United States
(12) Patent Application Publication
(10) Pub. No.: US 2014/0097131 A1
(43) Pub. Date: Apr. 10, 2014

(54) GREY WATER SYSTEM

(71) Applicant: Ervin Ernest Pettipas, Saint Louis, MI (US)

(72) Inventor: Ervin Ernest Pettipas, Saint Louis, MI (US)

(21) Appl. No.: 13/645,575

(22) Filed: Oct. 5, 2012

(51) Int. Cl. C02F 1/76

(52) U.S. Cl. CPC C02F 1/76
USPC 210/95; 210/198.1

(57) ABSTRACT

The present invention is a grey water system that through a single device and a single installation makes recycling grey water simple and cost effective. The single unit system is easy to install and to maintain. The system uses either 110 volt pumps or 12 volt making it usable in virtually any place. The system receives water through a skimmer to remove debris then proceeds into a holding tank or barrel. A predetermined amount of chlorine is added to remove bacteria. The water is then ready for use.

### BACKGROUND OF THE INVENTION

Grey water systems are not new to the art. The present invention has many advantages over the entire prior art devices. The primary advantage the instant device has over the prior art is that it is a single unit not a combination of component parts that have to be assembled.

U.S. Pat. No. 6,702,942; entitled “water Conservation Device, Kit and Method of Using” that issued on Mar. 9, 2004, to Richard E. Nield discloses a device that has pumps, filtration and holding capacity in separate devices. This prior art device requires extra pipe, valves and space to set the device up and to operate.

In U.S. Pat. No. 5,868,937; entitled “Process and System for Recycling and Reusing Gray Water” that issued on Feb. 9, 1999 to Dwight Douglas Beck offers a two tank system that also has the same short comings of Nield's in that the system has many components that require large areas of space to set up and to operate.

There are many more examples of the same nature, units that require more space and more cost in materials just to lay out the system.

The present invention includes a standard 110 volt system that is capable of connecting to a typical residential electrical system.

### THE INVENTION

The present invention is a single unit water saver control system comprised of a hollow holding tank. The hollow holding tank has a cover. The hollow holding tank cover has a pump, a waste water inlet tube surmounted by a filter, a waste water outlet tube, an electrical control box containing a switch and sufficient electrical wiring to connect to the electrical control box and an electrical source and to connect the electrical control box and the pump and a sanitizer dispenser module. The holding tank has an overflow pipe mounted in a side of the holding tank.

### BRIEF DESCRIPTION OF THE DRAWINGS

FIG. 1 is a shows the grey water system from the top.

FIG. 2 is a shows the grey water system from the side.

FIG. 3 is a shows the skimmer of the grey water system.

FIG. 4 is a shows the skimmer of the grey water system from one end.

FIG. 5 is a shows the chlorine dispenser of the grey water system.

FIG. 6 is a diagram of the electrical configuration for the 110 volt grey water system.

FIG. 7 is a diagram of the electrical configuration of the 12 volt grey water system.

FIG. 8 is shows the end of another embodiment of the grey water system 2 that is capable of hanging.

FIG. 9 shows the switch, skimmer and the pump.

FIG. 10 shows the overflow of the hanging embodiment.

FIG. 11 shows the viewing area of the hanging embodiment.

### DETAILED DESCRIPTION OF THE DRAWINGS

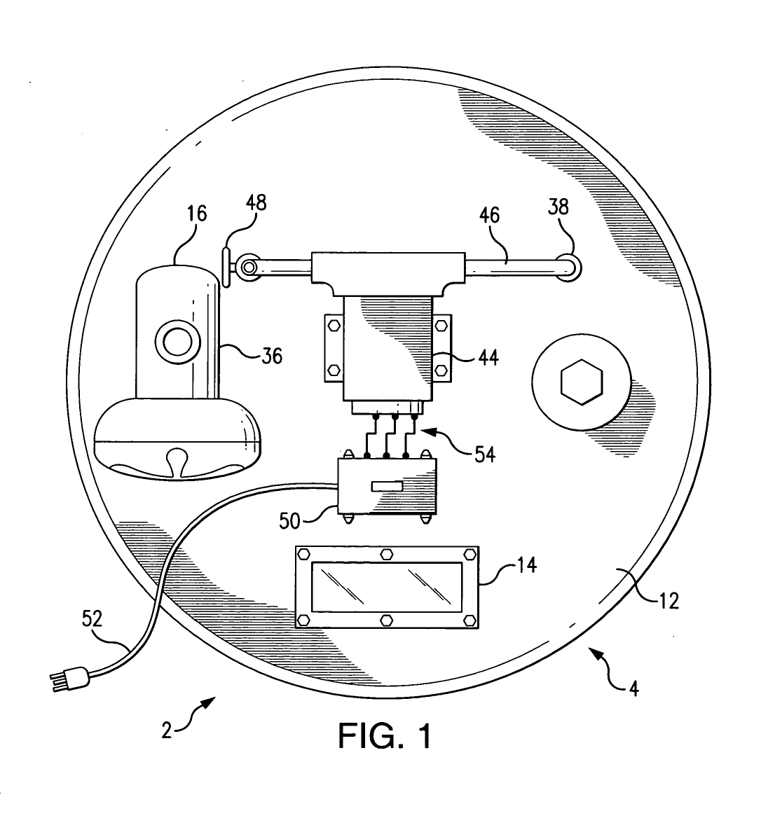

FIG. 1 shows the grey water system 2 from the top. The utility of the present invention focuses on the fact that this grey water system is all in one unit. A single installation in a single unit allows for the user to recycle large amounts of grey water on demand. The barrel 4 has top 12 at the near end 8. The top contains the inlet 36, the outlet 38 and the skimmer 16. Also shown on the top 12 are the viewing area 14, electrical switch 50, electrical cord 52 and electrical leads to the pump 44. There is also plumbing 46 that exits the outlet 38 and runs to the pump to force recycled water out of the grey water system 2.

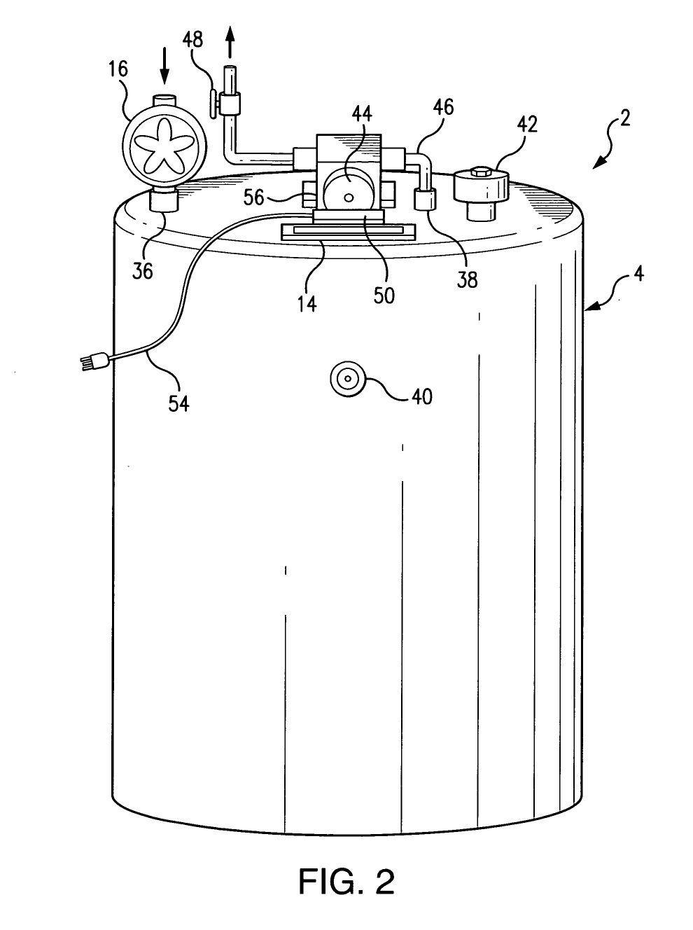

FIG. 2 shows the grey water system 2 from the side. The barrel 4 has a midsection 6 where the overflow 40 is located. Near the near end 8 of barrel 4 is the top 12. From this side view it is clear that the top 12 contains most of the working part for the grey water system 2. Connected to and sitting on top of the inlet 36 is the skimmer system 16 that is placed here to capture all debris from the raw grey water. The skimmer 16 works by trapping various articles as the water flows by force of gravity through the skimmer 16 and into the inlet 36 and further into the barrel for recycling. The opposite side of the top 12 houses the chlorine dispenser 42. The chlorine dispenser allows the metered addition of chlorine to the grey water system for purification purposes. The chlorine kills bacteria and germs that have made their way into the water from household use.

Once the water has changed from a raw status to a recycled status the water is ready for use as grey water and can now be dispensed from the barrel 4. In order to dispense the water from the barrel 4 the pump 44 must be electrically energized. The electrical plug 52 must be plugged into a 110 volt electrical system. Then the electrical switch 50 must be activated and the valve 48 must be open and the recycled water can make its way into use as grey water. The outlet 38 of the barrel plumbing 46 runs to the pump 44 then on to the grey water plumbing.

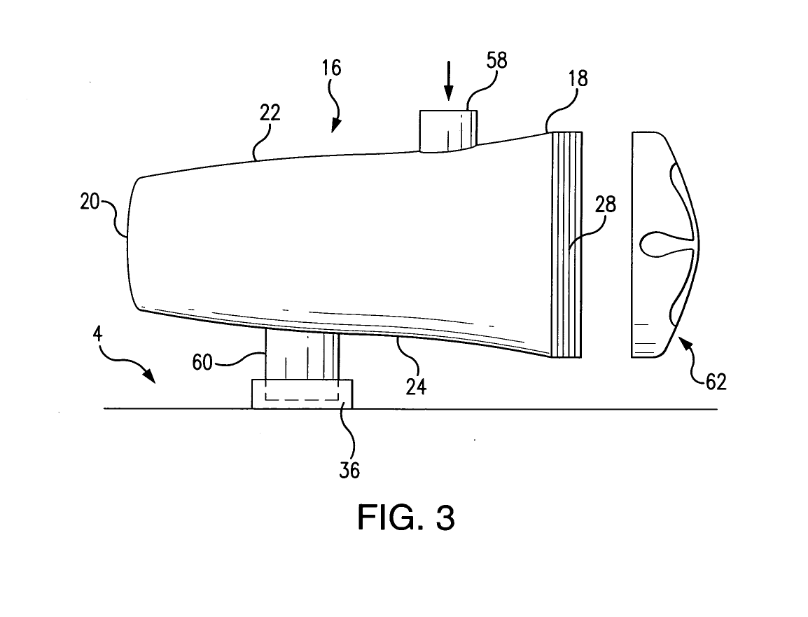

FIG. 3 shows the skimmer 16 of the grey water system 2 from the side. The skimmer 16 has an inlet 58 and an outlet 60. The raw water flows into the inlet 58 and is skimmed for debris and then exits through the outlet 60 of the skimmer 16 and into the inlet 36 of the barrel 4. The skimmer has a top 22, a bottom 24 a distal end 20 and a near end 18. The near end 18 of the skimmer 16 has a threaded end that contains an end cap 62.

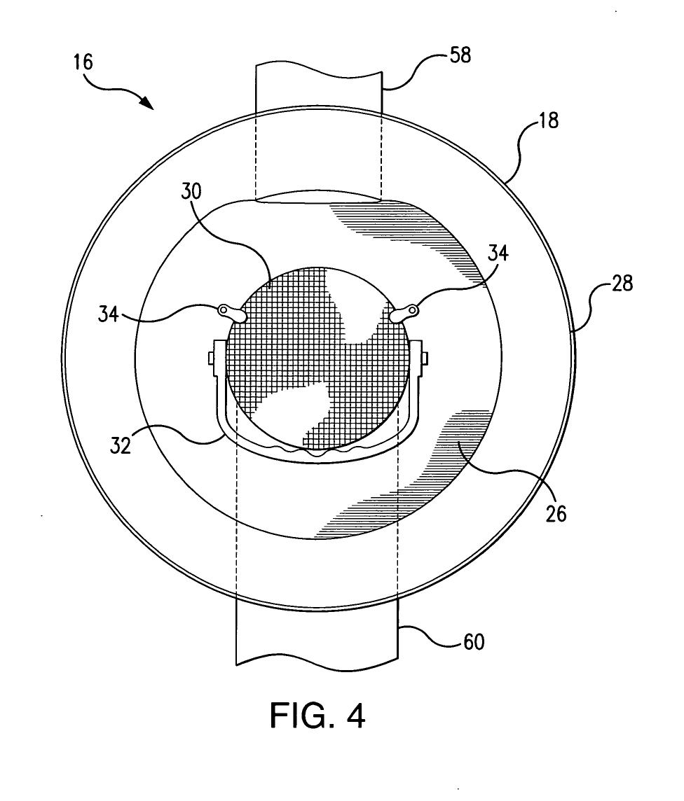

FIG. 4 shows the skimmer 16 of the grey water system 2 from the open end or near end 18 where threads hold the end cap 62 in place. The raw water flows in the inlet 58 into the inside 26 of the skimmer 16, then through the skimmer basket 30 where debris is removed. The skimmer basket 30 is designed to be removed for cleaning purposes and should be emptied and rinsed frequently. The water then flows from the skimmer 16 through the outlet 60 into the inlet 36 of the barrel 4. The skimmer basket 30 has a handle 32 to facilitate the removal of the skimmer basket 30 after the skimmer locks 34 have been manipulated. A predetermined amount of chlorine tablets are added to the skimmer basket 30 to chlorinate the grey eater in the tank as it passes through the skimmer basket 30.

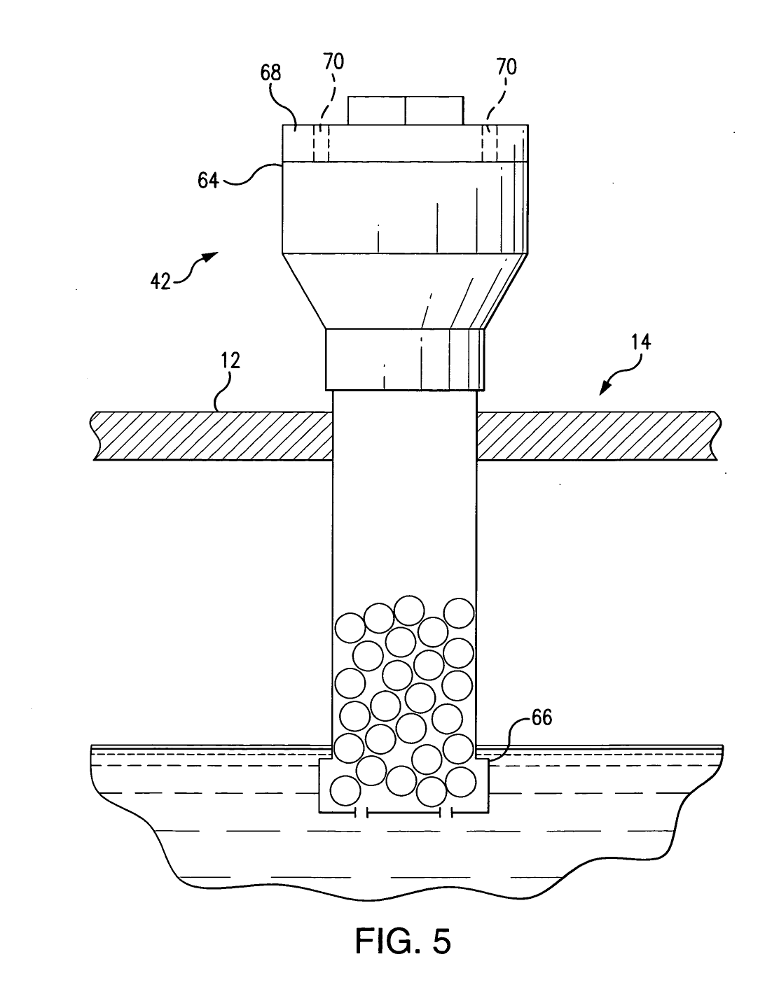

FIG. 5 shows the chlorine dispenser 42 of the grey water system 2. The chlorine dispenser 42 dispenses a predetermined amount of chlorine to disinfect the raw water and make it usable as grey water. The chlorine dispenser 42 has a near end 64 and a distal end 66 and projects from the top 12 of the barrel 4. The chlorine dispenser 42 has a vented cap 68 to prevent a vacuum from developing within the barrel 4. The cap 68 has at least two holes therethrough its top surface 70. The distal end 100 of the chlorine dispenser 42 is below the water level in the tank to facilitate dissolving into the grey water tank.

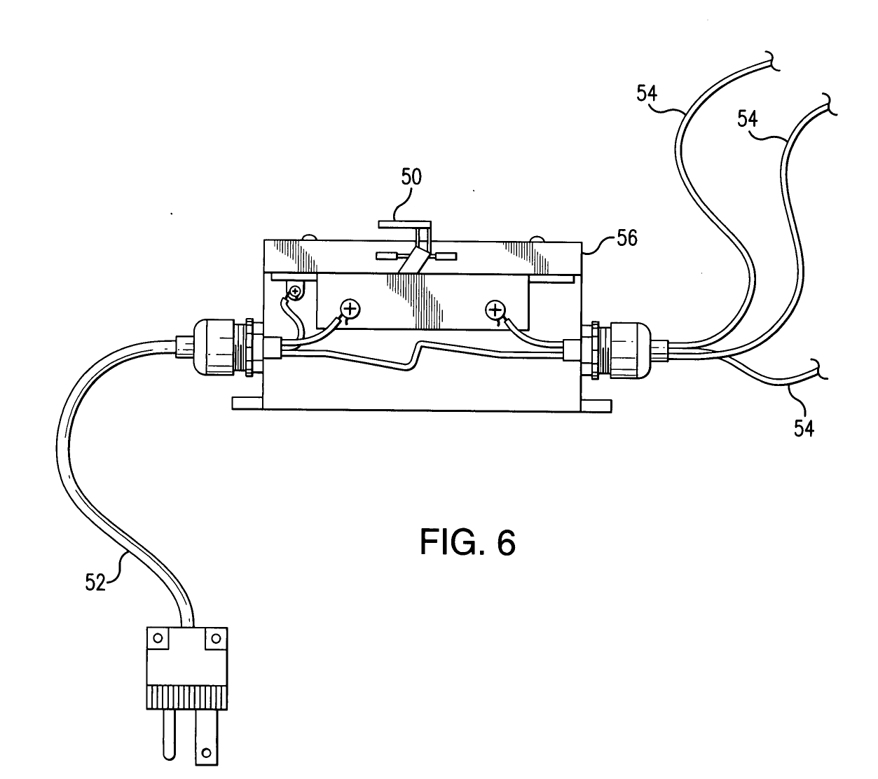

FIG. 6 shows the electrical configuration for the 110 volt all in one grey water system. The electrical configuration consist of an electrical box 56 with an electrical cord 52, an electrical switch 50 and electrical leads 54 that run to the water pump 44.

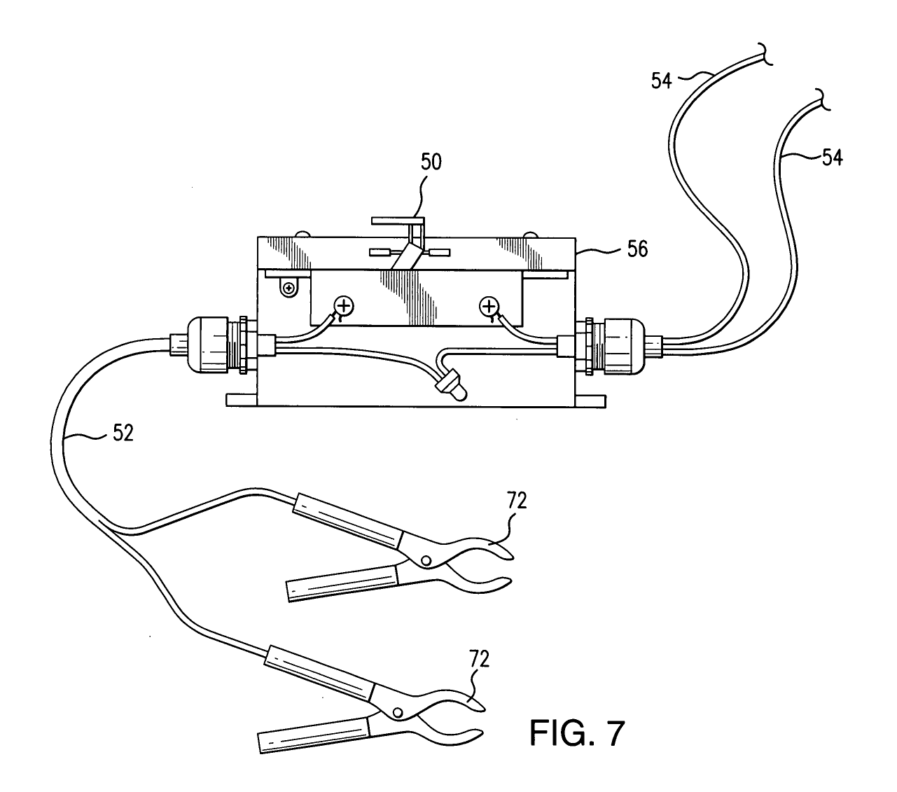

FIG. 7 shows the electrical configuration of the 12 volt water system. This electrical configuration consists of an electrical box 56 with an electrical cable with connecting clamps 72, an electrical switch 50 and electrical leads 54 that run to the water pump 44. This embodiment is designed for location without power or alternative power sources.

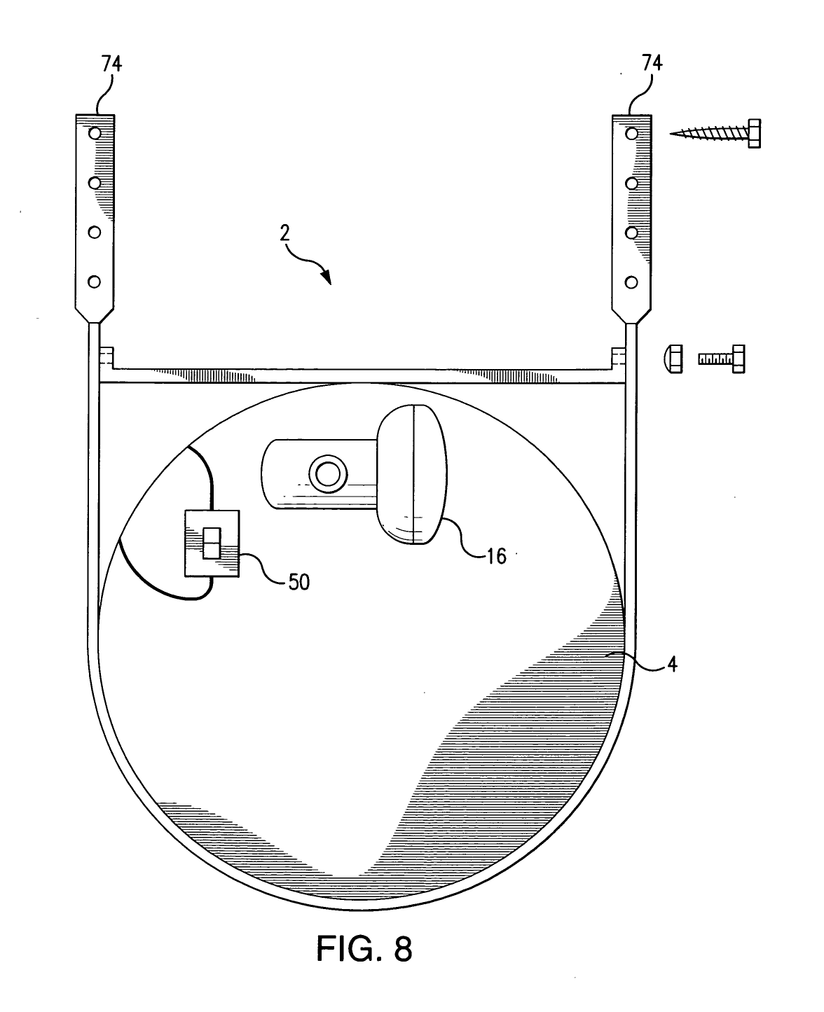

FIG. 8 is shows the end of another embodiment of the grey water system 2 that is capable of hanging. Visible here are the hangers 74 that allow the user to hang the device 2 from the floor joist in a basement or other area that will allow the unit to be hung. This end of the barrel 4 contains the electrical switch 50 and the skimmer 16.

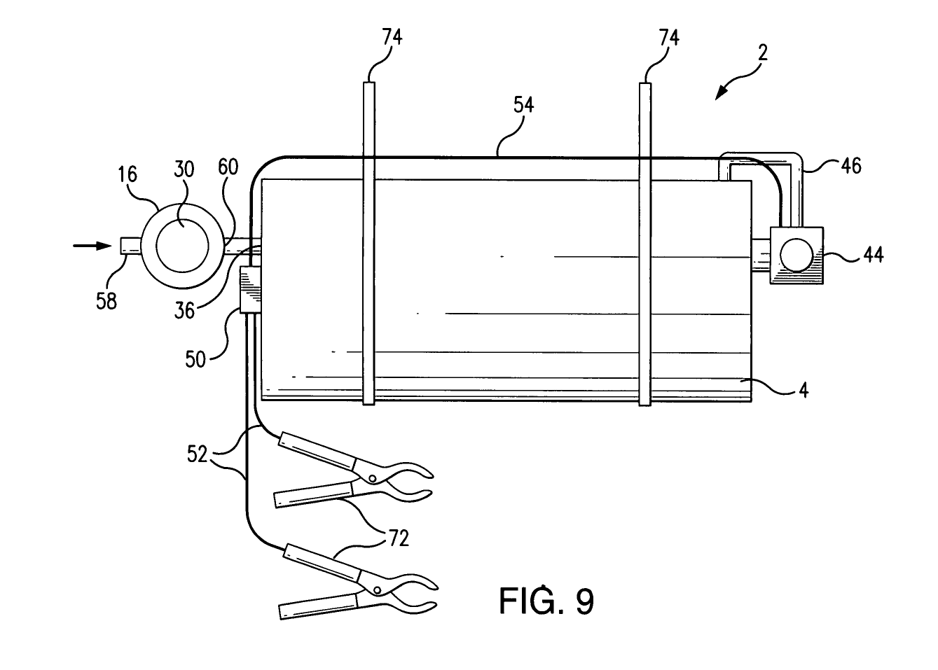

FIG. 9 shows the switch 50, skimmer 16 and the pump 44. The hangers 74 suspend the unit 2 from a floor joist in a basement or appropriate area. The electrical switch 50 and the skimmer 16 are located at one end. The skimmer basket 30 allows for the placement of a predetermined amount of chlorine table to be added to chlorinate the incoming grey water through the skimmer inlet 58 to stabilize it for storage. The grey water goes through the skimmer 16 to remove debris. It then the grey water passes the skimmer outlet 60 and into the barrel inlet 36. The electrical switch 50 is also located on the same end. The electrical leads 54 to the pump 44 are also visible. The electrical cord 52 has electrical clamps 72 at one end for connection to a battery or other alternative energy source. It should be know that this embodiment shows a DC connection but that one skilled in the art understands that an AC or DC source is acceptable without changing or altering the spirit of the invention. The other end of the barrel 4 contains the pump 44 and the piping 46 for the pump 44.

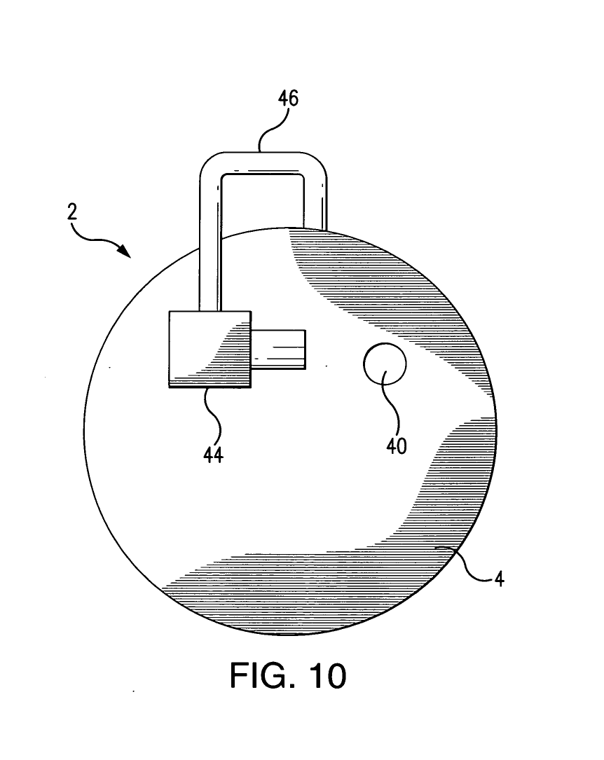

FIG. 10 shows the overflow 40 of the hanging embodiment. Also visible are the pump 44 and its mounting along with the piping 46 for the pump 44.

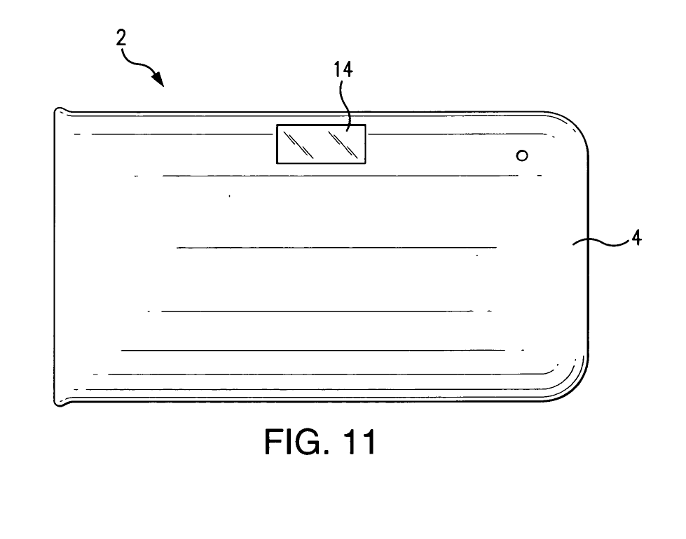

FIG. 11 shows the viewing area 14 of the hanging embodiment of the barrel 4 of the device 2.

The present invention has the pump and the filtration incorporated into the cover of the holding tank not only saving space and money in terms of materials used for the installation. Clearly the present invention has greater utility in time, space and money saving just to set up and operate.

Again the present invention allows the user to set up and operate its system less expensively and in a much smaller space.

The device also is manufactured to work on a 12 volt system for use in areas that are not on the power grid or if the user desires to use some alternative energy source, such as wind solar or water with a battery system.

What is claimed is:

1. A single unit water saver control system comprising:
A hollow holding tank having a cover, and mounted on said cover:
i. a pump;
ii. a waste water inlet tube surmounted by a filter;
iii. a waste water outlet tube;
iv. an electrical control box containing a switch and sufficient electrical wiring to connect to said electrical control box and an electrical source and to connect said electrical control box and said pump, and,
v. a sanitizer dispenser module,
said holding tank having an overflow pipe mounted in said holding tank.

2. A single unit water saver control system as claimed in claim 1 wherein said cover has, in addition, a viewing port installed therein.

3. In combination:
a. a single unit water saver control system as claimed in claim 1;
b. sufficient piping connecting at least one waste water source to the waste water inlet tube;
c. sufficient piping connecting the pump to a toilet stool;
d. a dip pipe attached to a bottom of said waste water outlet, and,
e. sufficient piping connecting said overflow pipe to a sewer system.

4. A single unit water saver control system as claimed in claim 3 wherein, in addition, c. has a shut off valve in said piping.

5. A single unit water saver control system as claimed in claim 1 wherein said electrical source is 110 volt electric power.

6. A single unit water saver control system as claimed in claim 1 wherein said electrical source is a 12 volt battery.

7. A single unit water saver control system comprising:
A hollow holding tank having sealed ends and an upper outside wall and mounted on said holding tank upper outside wall:
i. a pump;
ii. a waste water inlet tube surmounted by a filter;
iii. a waste water outlet tube;
iv. an electrical control box and sufficient electrical wiring to connect to said electrical control box and an electrical source and to connect said electrical control box and said pump, and,
v. a sanitizer dispenser module,
said holding tank having an overflow pipe mounted in a sealed end of said holding tank, said holding tank being supportable by hanging mounting straps;
sufficient electrical wiring to connect said electrical control box to an electrical source and to connect to said pump to said control box.

8. The single unit water saver control system as claimed in claim 7, wherein, in addition, there is a viewing port installed in the side wall of the holding tank.

9. A single unit water saver control system as claimed in claim 7 wherein said electrical source is 110 volt electric power.

10. A single unit water saver control system as claimed in claim 7 wherein said electrical source is a 12 volt battery.
